(19) United States
(12) Patent Application Publication
(10) Pub. No.: US 2011/0255064 A1
(43) Pub. Date: Oct. 20, 2011

(54) PHOTOLITHOGRAPHY METHOD AND DEVICE

(75) Inventors: Jerome Conraux, Trets (FR); Christiane Fantauzzo, Aix-en-provence (FR); Patrice Hamard, Aix en Provence (FR); Pierre Nunzi, La Ciotat (FR); Patrick Regnier, Biver (FR)

(73) Assignee: STMICROELECTRONICS (ROUSSET) SAS, Rousset (FR)

(21) Appl. No.: 13/085,857

(22) Filed: Apr. 13, 2011

(30) Foreign Application Priority Data
Apr. 20, 2010 (FR) 1001683

(51) Int. Cl. G03B 27/42

(52) U.S. Cl. 355/53; 355/77

(57) ABSTRACT

A photolithography method includes projecting a light beam through a mask onto a photosensitive layer to form on the photosensitive layer an image of a mask pattern formed by the mask, and controlling a layer of active elements of the mask so that the light beam after having traversed the layer of active elements, reproduces the mask pattern onto the photosensitive layer. The active elements are distributed throughout the layer of active elements in conformance with a matrical organization of lines and columns, each active element being individually controllable to take a state transparent to the light of the light beam, or else a state opaque to or reflecting of the light of the light beam, as a function of a command signal supplied to the active element.

### BACKGROUND

1. Technical Field

The present disclosure relates to photolithography, in particular for the fabrication of electronic circuits and of integrated circuits.

2. Description of the Related Art

The electronic and microelectronic industry uses photosensitive processes to form circuits on printed circuit boards or microcircuits on wafers of a semiconductor material. These processes implement one or more physical masks during the various fabrication steps. Depending on its configuration, positive or negative, each mask either hides or exposes a part of the wafer that is to be subjected to a process, such as a dopant implantation, the removal of a resist, the deposition of aluminum, etc. The fabrication of an integrated circuit may therefore require the use of several tens of masks, each mask corresponding to a processing step of the wafer.

The use of masks in the fabrication of printed or integrated circuits presents numerous inconveniences.

The cost linked to the use of masks is even higher when the fabrication of certain circuits requires a large number of masks and when a high level of precision of the pattern features is required. Handling, storing, and archiving problems may also arise. Once a mask has been made, it can no longer be modified. The modification of a circuit causes the modification of one, and often several, masks, thus requiring the fabrication of a new set of masks. Such a modification may therefore have a high cost and is therefore only done if absolutely necessary, limiting the innovation process and slowing down the evolution of circuits.

During the fabrication of circuits upon a wafer, the wafer is moved between several process stations of a processing line, and several stations may use a mask. For proper alignment, each wafer is precisely positioned under the mask so that the processing applied by the mask to the wafer coincides with a previous processing performed with another mask at a prior station. Moreover, the changing of masks at a processing station is a delicate operation. As a result, a processing line is dedicated, during a certain period of time, to the fabrication of one circuit, and it is delicate and fastidious to change the masks of a processing line so as to fabricate another circuit.

In general, the fabrication of the masks themselves is confided to an outside supplier. The circuit fabricant therefore submits all fabrication data of its circuits to the mask supplier, which may cause security and confidentiality issues.

All of the circuits produced by a processing line using a set of masks are identical. It is therefore impossible to produce different circuits without equipping the entire processing line with a new set of masks. It is also impossible to individualize the circuits. Moreover, the masks wear out and are regularly replaced. It results that a circuit produced with a new set of masks will not have the same qualities as a circuit produced with a set of masks nearing the end of their use. In the case of masks with critical dimensions, they are often replaced more frequently so as to avoid a high percentage of rejected circuits.

Certain fabrication steps of an integrated circuit, and in particular steps of cutting a resist or aluminum layer, may require the use of a laser. This solution provides a certain flexibility for modification of the circuit because it is relatively easy to modify the path of the laser beam on the circuit, but has the inconvenience of considerably increasing the processing time and decreasing the processing rate. In fact, the laser sweeps the entire circuit surface, and it is not possible to process several circuits in parallel with a single laser beam.

### BRIEF SUMMARY

One disclosed embodiment relates to a photolithography method comprising a step of projecting a light beam through a mask onto a photosensitive layer to form on the photosensitive layer an image of a mask pattern formed by the mask. According to an embodiment, the method comprises steps of controlling a layer of active elements of the mask, so that the light beam after having traversed the layer of active elements, reproduces the mask pattern onto the photosensitive layer, the active elements being distributed throughout the layer in conformance with a matrical organization of lines and of columns transversal to the lines, each active element being individually controlled to take a state transparent to the light of the light beam, or else a state opaque to or reflecting of the light of the light beam, or in other words, non-transparent to the light beam, as a function of a command signal supplied to the active element.

According to one embodiment, the method comprises steps of applying a command signal to each active element, to set the active element in a state defined by a transmission coefficient of the light of the beam, between a completely transparent state and a completely opaque or reflecting state.

According to one embodiment, the method comprises steps of controlling several superimposed layers of active elements of the mask, so that the ensemble of superimposed layers forms the mask pattern projected onto the photosensitive layer.

According to one embodiment, each active element of one of the layers is, in the direction of the light beam, exactly superimposed to an active element of another layer, or shifted in a direction perpendicular to the light beam with respect to an active element of another one of the layers.

According to one embodiment, the method comprises a step of supplying pattern data to a control unit controlling the layer of active elements to recreate a mask pattern corresponding to the pattern data.

According to one embodiment, the method comprises a step of depositing on a substrate a resist layer sensitive to the light of the light beam, performed before the projection step, and a development step consisting of removing, with the aid of a solvent, zones of the resist layer that were or were not exposed to the light beam through the mask.

Embodiments also relate to a method of fabrication of a circuit on a wafer, characterized in that it comprises steps of applying the photolithography method according to the method disclosed above to a substrate upon which is formed a photosensitive layer.

According to one embodiment, the method comprises a step of controlling active elements to define an identifying mark to uniquely identify circuits formed on the substrate into the mask pattern reproduced by the layer.

Embodiments also relate to a photolithography device comprising: a light source emitting a light beam to which a photosensitive layer is sensitive; a projection optic configured to transmit the light beam perpendicularly to a mask forming a mask pattern; a focusing optic configured to project the light beam that traversed the mask onto a layer photosensitive to the light beam and to form an image of the mask pattern on the photosensitive layer. According to an embodiment, the mask comprises a layer of active elements distributed in the layer in conformance with a matrical organization of lines and of columns transversal to the lines, each active element being individually controlled to take a state that is transparent to the light of the light beam, or a state that is opaque to or reflective of the light of the light beam, as a function of a command signal supplied to the active element.

According to one embodiment, the device comprises a control unit configured to supply to each active element a command signal, setting the active element in a state defined by a transmission coefficient of the light of the beam, between a completely transparent state and a completely opaque or reflecting state.

According to one embodiment, the device comprises several superimposed layers of active elements, and a control unit configured to control the ensemble of superimposed layers in order to form the image of the mask pattern on the photosensitive layer.

According to one embodiment, each active element of one of the layers is, in the direction of the light beam, exactly superimposed over an active element of another of the layers, or shifted in a direction perpendicular to the light beam with respect to an active element of another layer.

According to one embodiment, the control unit is configured to receive pattern data allowing a mask pattern to be recreated with the aid of one or more layers of active elements.

According to one embodiment, the focusing optic is configured so that the dimensions of the mask pattern are equal to one or more tens of times that of the image of the mask pattern projected onto the photosensitive layer.

### BRIEF DESCRIPTION OF THE SEVERAL VIEWS OF THE DRAWINGS Embodiment examples will be described in the following, in a non-limiting manner in relation with the appended figures among which:

FIG. 1 is a schematic perspective view of a photolithography projection device, according to an embodiment;

FIG. 2 is a schematic perspective view of a photolithography projection device, according to another embodiment; and

FIGS. 3A, 3B, and 3C schematically show different superimposition configurations of superimposed layers of active elements.

### DETAILED DESCRIPTION

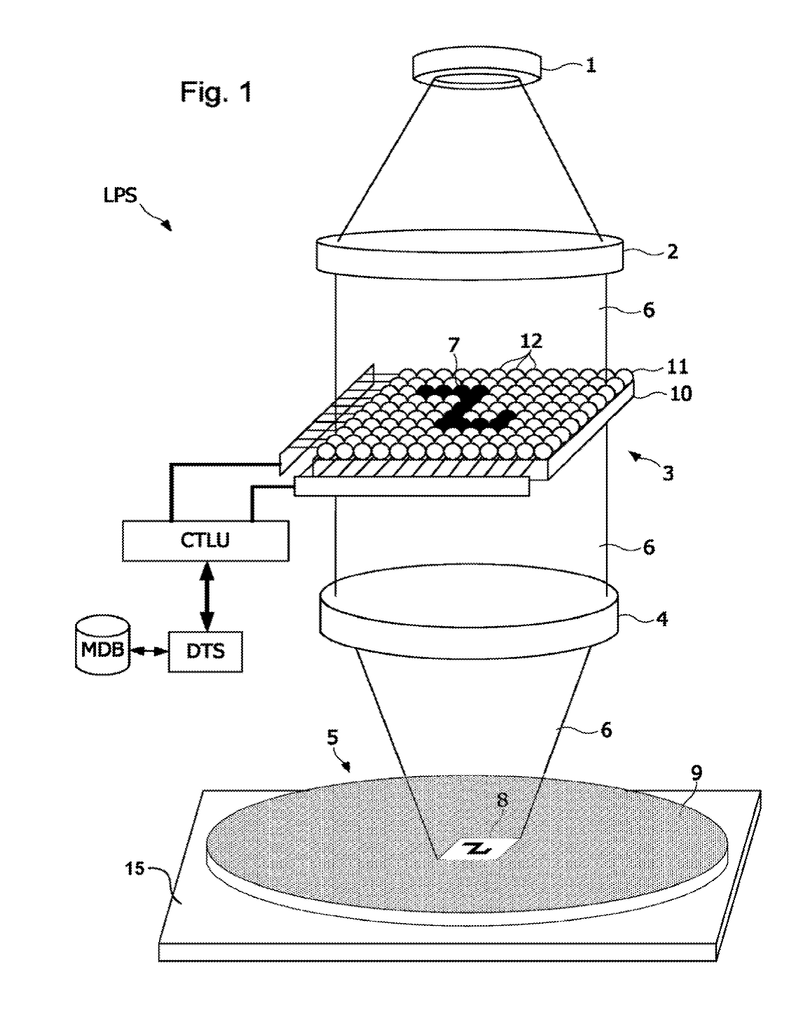

FIG. 1 shows a photolithography projection device. In FIG. 1, the projection device LPS comprises a light source 1 emitting a light beam 6, a projection optic 2, a mask 3, a focusing optic 4, and a support 15. The projection optic 2 conventionally comprises one or more lenses to transmit the light beam 6 coming from the source 1 to the mask 3. The focusing optic 4 conventionally comprises one or more lenses to focus the light that has traversed the mask 3 onto a zone 8 of a photosensitive layer 9 formed on the surface of a substrate 5 positioned on the support 15. The projection optic 2 may be configured to transform the divergent light beam emitted by the source 1 into a beam with parallel rays. The focusing optic 4 can thus be configured to project a sharp image of the pattern 7 of the mask onto the photosensitive layer 9 on the substrate 5. The projection device LPS thus allows a pattern formed by the mask 3 to be projected onto the zone 8 so as to obtain one or more circuits. The substrate 5 may be, for example, a printed circuit board substrate or a semiconductor material wafer. The optics 2 and 4 may be configured so that the light rays of the beam 6 are collimated, i.e., parallel to each other and reach the mask 3 perpendicularly.

According to one embodiment, the mask 3 comprises a layer 11 of active elements 12 arranged according to a matrical organization of lines and of columns transversal to the lines. Each active element 12 is individually controlled so as to be in a transparent state for the light emitted by the source 1, or else in a non-transparent state, i.e., an opaque or reflecting state, depending upon an electric control signal supplied to the active element by a control unit CTLU. The individual control of the active elements 12 may be done for example by a conventional row and column addressing device. The layer 11 may be formed upon a substrate 10 of a material transparent to the light emitted by the source 1. The control unit CTLU is configured to control the layer 11 in a manner so as to make a pattern appear corresponding to pattern data supplied by a mask server. To this end, the mask server DTS has access to a database MDB storing pattern data in a digital format.

The database MDB may therefore store pattern data allowing all the mask layers necessary for the fabrication of several circuits to be recomposed on the layer 11. If a circuit is to be modified, it is simple to modify one or more of the mask patterns stored in the database MDB. It is equally possible to modify a mask pattern in a dynamic manner for each new substrate 5 introduced into the device LPS. For example, this arrangement allows each substrate or each circuit on the substrate to be marked with a unique identification code, for example a bar code that is generated and inserted in the mask pattern by the control unit CTLU at the start of processing of a new wafer with a mask pattern.

The server DTS may be connected to several projection devices such as that shown in FIG. 1. Thus, several devices LPS may be used to fabricate a same circuit in order to increase production rate, each mask pattern necessary for the fabrication of the circuit being sent to the devices LPS. Several processing lines, each comprising one or more devices LPS, may be connected to the server DTS. The attribution of a fabrication line to a circuit may also be easily modified by controlling the server DTS so that it distributes the masks sets to the processing lines according to the circuits to be fabricated on each line.

The layer 11 may be of the transparent display type, for example of nematic and/or cholesteric liquid crystals, of the Transparent Organic Light Emitting Diode (TOLED) type, or comprising a layer of electrochromic elements. Examples of such displays have already been described in numerous published documents. Therefore, for further detail concerning the makeup and the functioning of such displays, one may refer to the patents U.S. Pat. Nos. 7,742,216; 6,104,367; 5,764,319 or patent application US 2010/0085522, for example, all of which are incorporated herein by reference in their entireties.

According to one embodiment, each active element 12 is configured to assume a state defined by a transmission coefficient of the light emitted by the source 1, from a completely transparent state to a completely opaque or reflecting state, as a function of a command signal supplied by the control unit CTLU. Thanks to this arrangement, the contours of the projected image 8 of the mask pattern on the photosensitive layer 9 may be smoothed by adjusting the transmission coefficient of the active elements 12 situated near the pattern contours.

For alignment and stepping purposes, the support 15 may be movable along one or more axes, and may also be rotatable around a vertical axis.

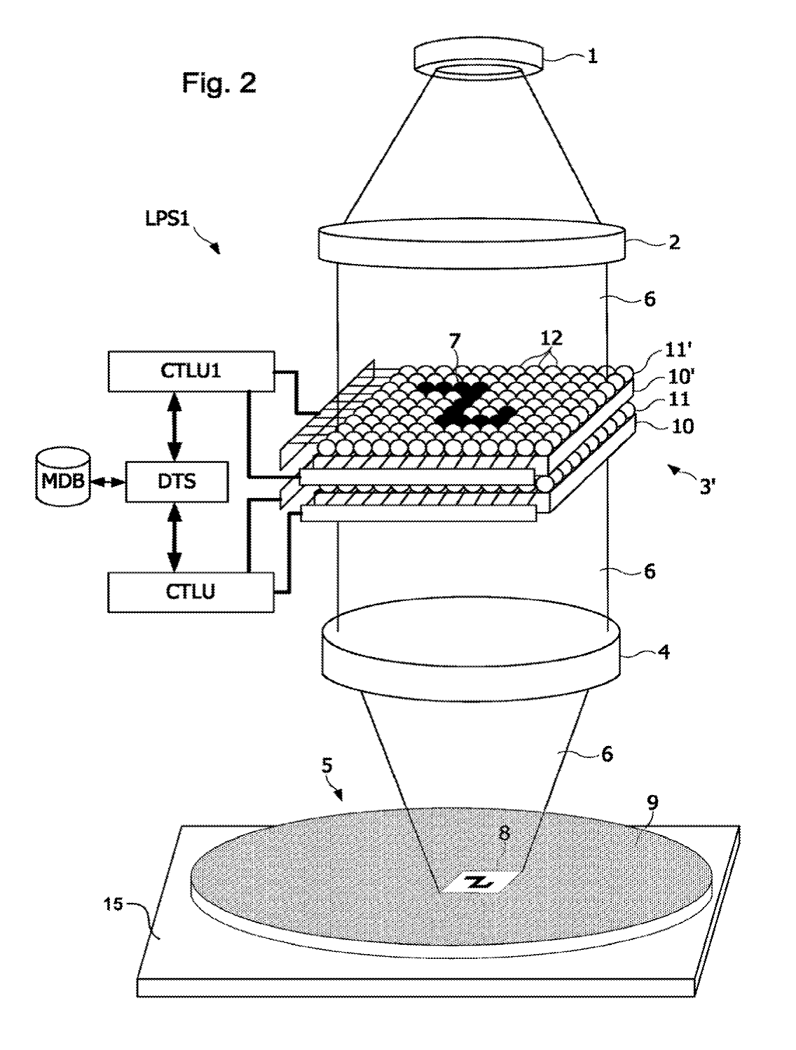

FIG. 2 shows a photolithography projection device according to another embodiment. In FIG. 2, the projection device LPS1 differs from that of FIG. 1 in that it comprises a mask 3′ comprising two or more superimposed identical layers 11, 11′. Each layer 11, 11′ is controlled by a control unit CTLU, CTLU1 configured to control the active elements 12 of one of the two layers 11, 11′ in a manner such that the ensemble of superimposed layers reproduces a mask pattern 7. Each layer 11, 11′ may be formed on a respective transparent substrate 10, 10′ or else a single transparent substrate supporting all the layers 11, 11′. The mask patterns supplied by the mask server DTS to the layers 11, 11′ may be identical or different. If they are different, the mask patterns selected in the database MDB and transmitted to layers 11, 11′ are configured so that their superimposition allows a desired pattern image to be formed on the photosensitive layer 9. It should be noted that this superimposition of layers is possible if the ensemble of light rays of beam 6 arrive perpendicularly to the mask 3.

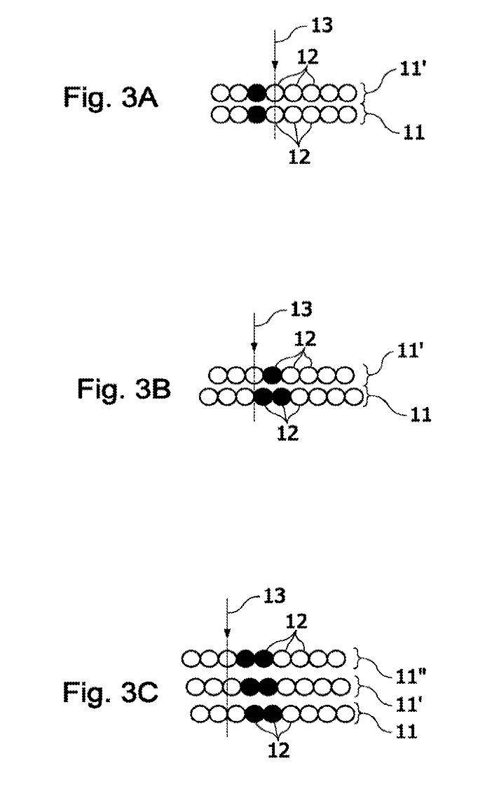

The superimposition of several layers 11, 11′ allows, if necessary, a greater opacity of the mask pattern with respect to the light emitted by the source 1 to be obtained, or an increase of the definition of the mask pattern, and thus the refinement of mask patterns susceptible of being formed on the photosensitive layer 9 on the substrate 5. Thus, FIGS. 3A to 3C show different configurations of superimposed layers of active elements. To increase the opacity of the mask pattern, the active elements 12 of each layer 11, 11′ may be precisely superimposed in the direction 13 of the light beam (FIG. 3A). If the definition of the mask pattern is to be improved, the active elements 12 of a layer may be shifted (in a direction perpendicular to that of the light beam) with respect to the active elements of the other layer in the direction 13 of the light beam (FIG. 3B). It should be noted that if the two layers 11, 11′ are superimposed in the configuration of FIG. 3B, the opacity of the mask constituted by the two layers is also found to be increased. The shift of active elements 12 of one layer 11 with respect to those of the other layer 11′ is not necessarily equal to the pitch or to the half-pitch of the active elements, but may be equal to a fraction of this dimension, in particular if the mask comprises more than two layers 11, 11′, as shown in FIG. 3C. FIG. 3C thus shows three layers 11, 11′, and 11″. Layers 11 and 11″ are shifted one with respect to the other at a distance equal to the radius of the active elements 12, whereas the layer 11′ arranged between the two layers 11 and 11″, is shifted with respect to the other two layers at a distance equal to half the radius of the active elements.

To increase the definition of the projected image 8, it may also be envisaged to increase the reduction ratio of the focusing optic 4 (relation between the dimensions of the mask pattern 7 and those of the image 8 on the photosensitive layer 9). The increase of this ratio leads to a reduction of the size of the image of the pattern 8 projected on the photosensitive layer 9, and/or an increase of the mask 3 dimensions to have more active elements 12, and thereby the dimensions of the projection optics 2 and focalization optics 4. The reduction ratio of the focusing optic 4 is conventionally on the order of 4 or 5 times, but may be increased to one or several tens, for example 10 or 20 times.

It should be noted that in varying the size of the pattern 8, the circuit fabrication speed is affected, whereas in varying the size of the mask, the cost and the size of the projection device LPS, LPS1 are affected, and in particular the cost and size of lenses of the projection 2 and focalization 4 optics. These optics should be, as far as possible, free of optical flaws so as to avoid deformation of the projected pattern 8 with respect to the mask pattern 7.

One embodiment relates in particular to the fabrication of integrated circuits, in particular with the aim of forming a positive resist mask on the surface of a wafer of a semiconductor material. Such resist masks are used to implement an etching or an implantation, and serve to protect zones that should not be etched or implanted. After the etching or implantation operation, the resist mask is removed.

In a first step of a photolithography method, a resist is deposited onto and spread over a wafer of a semiconductor material. The spreading of the resist on the wafer is generally performed by centrifugation by depositing the resist at the center of the wafer and making it spin about its axis. The type of resist and the rotation speed of the wafer are important factors to standardize and control the thickness of the resist layer.

In a second step, the wafer is placed in a mask pattern projection device LPS, LPS1. This step consists of exposing certain areas, defined by a mask pattern, of the resist layer on the substrate 5 to a beam of light of which the energy is able to chemically alter all of the exposed areas of the resist layer so as to make them soluble in a suitable solvent. If the projected image 8 does not cover almost the entire substrate 5, this step is repeated as many times as desired by moving the support 15 to reposition the wafer with respect to the projected light beam 6. In general, alignment marks are provided in the mask pattern to allow successively projected patterns to be aligned with each other. The wafer may then be heated to harden the non-exposed resist and thus obtain straight profiles after a development step.

In a third fabrication step, the resist of the wafer is placed in contact with a solvent that dissolves the zones that were exposed to the energy of the light beam 6. The solvent may be deposited on resist at the center of the wafer that is rotated about its axis, so as to cover the entire resist layer. The wafer is then rinsed in water and then dried. It may also be heated to harden the remaining resist and to give it a resistance so that it is capable of withstanding an etching or implantation operation. It should be noted that in certain methods implementing other types of photosensitive resists and other solvents, it is on the contrary the zones exposed to the light beam that become insoluble to the solvent used during the development step. In this case, the development step allows the zones that were not exposed to the light beam to be removed.

The quality of the resist mask thus formed on the substrate 5 depends upon the properties of the chosen resist, the exposition time of the resist layer, the sharpness and the definition of the image 8 of the mask, and the energy supplied by the light beam (that depends upon its wavelength).

It will clearly appear to the skilled person that embodiments are susceptible of diverse implementation variations and applications. In particular, the photolithography method previously described does not necessarily apply to the fabrication of an integrated circuit or to the fabrication of a circuit on a printed circuit board. This photolithography method may apply to all fields where such techniques are known to be implemented.

Moreover, the step of depositing the photosensitive layer is not always necessary because the substrate upon which the photolithography is performed may already comprise such a layer, as is the case of commercialized printed circuit boards.

It should further be noted that a pattern server such as the server DTS is not essential. A control unit may, for example, be provided that stores the mask patterns and controls the active elements 12 to reproduce one of the stored mask patterns.

The various embodiments described above can be combined to provide further embodiments. All of the U.S. patents, U.S. patent application publications, U.S. patent application, foreign patents, foreign patent application and non-patent publications referred to in this specification are incorporated herein by reference, in their entirety. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A photolithography method for manufacturing circuits, the method comprising:
projecting a light beam through a mask onto a photosensitive layer deposited on a substrate to form on the photosensitive layer an image of a mask pattern formed by the mask;
controlling a layer of active elements of the mask, so that the light beam, after having traversed the layer of active elements, reproduces the mask pattern onto the photosensitive layer, the active elements being distributed throughout the layer in conformance with a matrical organization of lines and of columns transversal to the lines, each active element being individually controlled to take a state transparent to the light of the light beam, or else a state that is not transparent to the light of the light beam, as a function of a command signal supplied to the active element, the mask pattern reproduced by the layer defining an identifying mark that uniquely identifies each of a plurality of circuits formed on the substrate.

2. The method according to claim 1, comprising applying a command signal to each active element, to set the active element in a state defined by a transmission coefficient of the light of the beam, between a completely transparent state and one of a completely opaque state or a reflecting state.

3. The method according to claim 1, comprising controlling several superimposed layers of active elements of the mask, so that the ensemble of superimposed layers forms the mask pattern projected onto the photosensitive layer.

4. The method according to claim 3, wherein each active element of one of the layers is, in the direction of the light beam, exactly superimposed to an active element of another layer.

5. The method according to claim 3, wherein each active element of one of the layers is, in the direction of the light beam, shifted, in a direction perpendicular to the light beam with respect to an active element of another one of the layers, a distance of less than a pitch length of the active elements of one of the layers.

6. The method according to claim 1, comprising supplying pattern data to a control unit controlling the layer of active elements to recreate a mask pattern corresponding to the pattern data.

7. The method according to claim 1 wherein the photosensitive layer is a resist layer, the method comprising:
depositing the resist layer on a substrate; and
removing, with the aid of a solvent, zones of the resist layer that remain soluble to the solvent following processing that includes exposure of the resist layer to the light beam through the mask during the projecting.

8. The method of claim 1 wherein projecting the light beam comprises projecting a light beam onto a photosensitive layer positioned on a substrate that is one of a semiconductor material wafer or a circuit board substrate.

9. (canceled)

10. A photolithography device for manufacturing circuits, the device comprising:
a light source configured to emit a light beam;
a projection optic configured to transmit the light beam;
a mask having a layer of active elements distributed in the layer in conformance with a matrical organization of lines and of columns transversal to the lines, each active element being individually controllable to take a state that is transparent to the light of the light beam, or a state that is not transparent to the light of the light beam, as a function of a command signal supplied to the active element, the mask being positioned so as to transmit the light beam, and configured to have a mask pattern formed by the active elements, the mask pattern reproduced by the layer defining an identifying mark that uniquely identifies each of a plurality of circuits to be formed on a substrate; and
a focusing optic configured to project the light beam transmitted by the mask onto a layer photosensitive to the light beam and to form an image of the mask pattern on the photosensitive layer.

11. The device according to claim 10, comprising a control unit configured to supply to each active element a command signal, setting the active element in a state defined by a transmission coefficient of the light of the beam, between a completely transparent state and a completely non-transparent state.

12. The device according to claim 10, comprising a plurality of superimposed layers of active elements, and a control unit configured to control the ensemble of superimposed layers in order to form the image of the mask pattern on the photosensitive layer.

13. The device according to claim 12, wherein each active element of one of the layers is, in the direction of the light beam, exactly superimposed over an active element of another of the layers.

14. The device according to claim 11, wherein the control unit is configured to receive pattern data allowing a mask pattern to be recreated with the aid of one or more layers of active elements.

15. The device according to claim 10, wherein the focusing optic is configured so that the dimensions of the mask pattern are at least one order of magnitude larger than corresponding dimensions of the image of the mask pattern projected onto the photosensitive layer.

16. The device according to claim 11, comprising a database coupled to the control unit and configured to store a plurality of mask patterns.

17. The device according to claim 10, comprising a support element configured to support a substrate in a position to be exposed to the light beam from the focusing optic.

18. The device according to claim 17 wherein the support element is configured to move in a step-and-repeat operation to permit repeated exposures of a same substrate to the light beam at different respective locations on the substrate.

19. A method, comprising:
in a mask device having a plurality of active elements arranged in rows and columns in a layer of a transparent substrate, define a selected mask pattern by commanding each of the active elements to assume a respective selected degree of opacity according to a position of the respective active elements in the layer; and
projecting the selected mask pattern onto a photosensitive layer on a substrate by transmitting a light beam through the mask and focusing the transmitted beam onto the photosensitive layer, the mask pattern reproduced by the layer defining an identifying mark that uniquely identifies each of a plurality of circuits to be formed on the substrate.

20. The method of claim 19, comprising:
moving a support element that supports the substrate in a position to be exposed to the light beam; and
projecting the selected mask patter onto the photosensitive layer at a different location on the photosensitive layer, as determined by the moving.

21. The method of claim 19, comprising, prior to the projecting, aligning the mask with alignment marks previously formed on the substrate.

22. The method of claim 19, comprising, following the projecting, defining a different selected mask pattern by commanding each of the active elements to assume a respective selected degree of opacity.

23. The method of claim 22, comprising, projecting the different selected mask pattern onto the photosensitive layer in a position aligned with a position of the selected mask pattern.

24. The method of claim 22, comprising, projecting the different selected mask pattern onto the photosensitive layer in a position different from a position of the selected mask pattern.

25. The method of claim 19 wherein the projecting comprises projecting the selected mask pattern onto the photosensitive layer at a size that is reduced by at least one order of magnitude, relative to a size of the mask pattern as defined by the plurality of active elements.
